(19) United States
(12) Patent Application Publication
(10) Pub. No.: US 2015/0312093 A1
(43) Pub. Date: Oct. 29, 2015

(54) SYSTEM AND METHOD FOR INPUT AND OUTPUT BETWEEN HARDWARE COMPONENTS

(71) Applicant: General Electric Company, Schenectady, NY (US)

(72) Inventors: Steven Woloschek, Franklin, WI (US); Nathanael Huffman, Oconomowoc, WI (US); Brian Breuer, Allenton, WI (US); Eric Aasen, Pewaukee, WI (US); Philip Huettl, Waukesha, WI (US)

(73) Assignee: General Electric Company, Schenectady, NY (US)

(21) Appl. No.: 14/264,210

(22) Filed: Apr. 29, 2014

(51) Int. Cl. H04L 12/24; H04L 5/00; H04L 12/947

(52) U.S. Cl. CPC H04L 41/0803; H04L 49/25; H04L 5/0044

(57) ABSTRACT

A system and method is provided for input and output between networked hardware components. The system can convert hardware control signals into network frames for transmission over a network fabric. Meta-data or data payload information may also be transmitted. The system can then receive network frames and convert them into replicated hardware control signals for execution. Multiple hardware components can work together for execution of coordinated actions.

### RELATED APPLICATIONS

This application is related to U.S. patent application Ser. No. 14/051,137, filed Oct. 10, 2013, and entitled “SYSTEM AND METHOD FOR SYNCHRONIZING NETWORKED COMPONENTS”, which is incorporated by reference herein in its entirety.

### BACKGROUND

The subject matter disclosed herein relates generally to communication between hardware (HW) components.

Many industries require hardware system components to communicate between each other at very fast speeds and with high reliability. For example a medical image acquisition requires high speed sampling and signaling between various subsystems. Medical image acquisition systems could be CT, MRI, x-ray, PET, SPECT, or other diagnostic systems. Additional exemplary industries are those in automotive, aviation, locomotive, manufacturing, and others. The conventional communication method is to use physical wires in custom cabling to transmit digital input and output (IO) signals between subsystems. As new features demand additional signaling, systems may require physical re-design of processors, circuit boards, and cabling to accommodate. This can lead to problems, especially in hardware products with long lifespans or hardware installed in difficult to access locations. Further, some systems cannot have additional cabling or physical modifications due to system layout or space constraints.

A networked communication system is needed that provides for reliable communication between hardware components and the flexibility to adjust the communication system without requiring redesign of circuit boards and physical adjustments to communication cabling.

### BRIEF DESCRIPTION

In accordance with an embodiment, a communication system is disclosed, comprising a first communication unit; a first hardware apparatus connecting to the first communication unit; a second communication unit; a network fabric connecting the first communication unit and the second communication unit; wherein the second communication unit receives a hardware control signal, converts the hardware control signal into network frames including an execution time, and transmits the network frames to the first communication unit via the network fabric; wherein the first communication unit receives the network frames, converts the network frames into a replicated hardware control signal, and transmits the replicated hardware control signal to the first hardware apparatus; and wherein the first hardware apparatus performs an action based on the replicated hardware control signal at the execution time. The second communication unit can transmit periodic refresh frames if the hardware control signal state remains asserted.

Further, the communication system can have the first communication unit, after receiving a related network frame and before the execution time, sends a pre-notify signal to the hardware apparatus; and the first hardware apparatus, after receiving the pre-notify signal and before the execution time, performs preparatory functions related to the replicated hardware control signal. The system can also have a second hardware apparatus connecting to the second communication unit; wherein the second communication unit receives second network frames including hardware control information and a second execution time, converts the second network frames into a replicated hardware control signal, and transmits the replicated hardware control signal to the second hardware apparatus at the execution time.

A coordinated action, or scheduled event, is also an aspect of the system with a third communication unit connected to the network fabric; a third hardware apparatus connected to the third communication unit; wherein the third communication unit receives the network frames, converts the network frames into a replicated hardware control signal, and transmits the replicated hardware control signal to the third hardware apparatus; and wherein the third hardware apparatus performs a coordinated action with the first hardware apparatus based on the replicated hardware control signal. The first communication unit can comprise a buffer; and the first communication unit can store multiple hardware control signals for transmission to the first hardware apparatus and their respective execution time in said buffer. This supports pipelining.

In accordance with an embodiment, a communication method is disclosed, for a communication system with a network fabric connecting multiple communication units, comprising: receiving a hardware control signal on a source communication unit from a source hardware device; converting the hardware control signal into one or more RTL frames by the source communication unit, the RTL frames comprising an execution time; transmitting the RTL frames from the source communication unit to one or more destination communication units over the network fabric; receiving the RTL frames at the one or more destination communication units; converting the RTL frames into replicated hardware control signals by the one or more destination communication units; storing the replicated hardware control signals in the one or more the destination communication units until the execution time; transmitting, at the execution time, the replicated hardware control signals to one or more destination hardware devices by the respective one or more destination communication units.

The method can also include transmitting, by a plurality of destination communication units, the replicated hardware control signal to their respective destination hardware devices at the same execution time; and performing, by the destination hardware devices, a coordinated action based on the replicated hardware control signal. Further, the method can include transmitting, after receiving a related network frame and before the execution time, a pre-notify signal from at least one destination communication unit to its respective destination hardware device; and performing, by the respective destination hardware device after receiving the pre-notify signal and before the execution time, preparatory functions related to the replicated hardware control signal.

According to an embodiment, a communication method is disclosed, comprising receiving a network frame from a network fabric, the network frame comprising hardware control signal information and an execution time; converting the network frame into a replicated hardware control signal; and outputting the replicated hardware control signal to a hardware apparatus to complete an action at the execution time. Further, each frame may comprise a priority field, an opcode field, and data payload information.

The system and method can be implemented with the first communication unit implemented on a gantry control board; and with having the hardware apparatus be one of an x-ray tube, an image detector, a collimator, or a data acquisition system. Coordinated actions can be imaging actions. The network fabric, hardware devices, and communication units can be at least partially supported by a medical imaging gantry.

### BRIEF DESCRIPTION OF THE DRAWINGS

FIG. 1 shows a block diagram of a hardware system using virtualized IO, according to an embodiment.

FIG. 2 shows a block diagram detailing RTL logic within a hardware system, according to an embodiment.

FIG. 3 shows an example RTL frame, according to an embodiment.

FIG. 4 shows the timing and execution an RTL scheduled event, according to an embodiment.

FIG. 5 shows the timing and execution an RTL state event, according to an embodiment.

FIG. 6 shows the timing and execution an RTL state event with pre-notify signaling, according to an embodiment.

FIG. 7 shows the execution an RTL unscheduled state, according to an embodiment.

FIG. 8 shows a perspective view of a CT system, according to an embodiment.

FIG. 9 shows a block diagram of a CT system, according to an embodiment.

### DETAILED DESCRIPTION

The foregoing summary, as well as the following detailed description of certain embodiments and claims, will be better understood when read in conjunction with the appended figures. To the extent that the figures illustrate diagrams of the functional blocks of various embodiments, the functional blocks are not necessarily indicative of the division between hardware circuitry. Thus, for example, one or more of the functional blocks (e.g., processors, controllers or memories) may be implemented in a single piece of hardware (e.g., a general purpose signal processor or random access memory, hard disk, FPGA, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

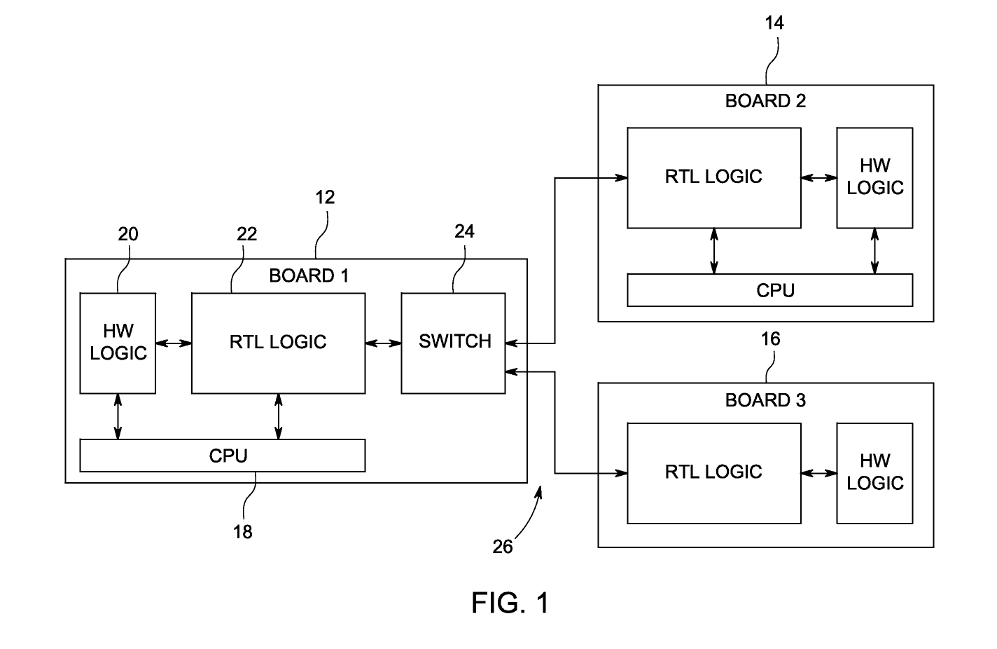

FIG. 1 shows a block diagram of a hardware system using virtualized IO, according to an embodiment. FIG. 1 details a method and apparatus for virtualized IO over a time synchronized, switched network fabric to control one or a plurality of hardware devices in order to accomplish individual and coordinated tasks in a hardware system. By virtualizing the digital IO signals over a high-speed switched network fabric, the system eliminates the need to physically redesign components for additional digital IO signals. The system utilizes real-time-lines (RTLs), as discussed and defined further below.

Circuit boards 12, 14, and 16 are exemplary electrical circuit boards that each interact with and/or control a hardware device. Circuit boards 12, 14, and 16 coordinate to interact with and control a hardware system to complete actions and tasks. These actions can be synchronized and coordinated across multiple hardware devices.

Circuit board 12 comprises CPU 18, HW logic 20, RTL logic 22, and switch 24. Circuit board 12 can be embedded in, installed into, attached to, remote from, or set nearby a hardware apparatus that it interacts with and/or control, according to alternative embodiments. Connections from circuit board 12 to its associated hardware apparatus or multiple apparatuses exist, but are not shown in FIG. 1.

CPU 18 is a central processing unit, a processor (e.g. ASIC, FPGA) or conventional processor, typically operating at a high instruction throughput. CPU 18 may control many aspects of the system other than those shown in FIG. 1 as would be known to those with skill in the art.

HW logic 20 interfaces with the hardware apparatus, CPU 18, and RTL logic 22. HW Logic 20 sends hardware control signals to RTL logic 22 for communication across fabric 26. HW logic 20 receives replicated hardware control signals from RTL logic 22 that were received from fabric 26. Hardware control signals can logically be 1's and 0's along conductive lines to hardware components and subsystems. Logic 1's and 0's may represent certain voltages (such as 1 logic=3 volts, 0 logic=0 volts). HW logic 20 can be an application specific integrated circuit (ASIC) designed for a specific hardware device, according to some embodiments. In other embodiments, HW logic 20 can be a re-programmable FPGA that controls a generic hardware device or multiple hardware devices.

RTL logic 22, a communication unit, converts hardware control signals from HW logic 20 and CPU 18 into network frames for transmission to fabric 26 utilizing switch 24. RTL logic 22 also converts received network frames into replicated hardware control signals to be sent to HW logic 20. RTL logic 22 is discussed further below.

Circuit board 14 includes CPU, HW Logic, and RTL logic units similar to circuit board 12, but that are tailored for the specific hardware it interacts with and/or controls. Circuit board 14 does not include a switch in this embodiment to show the various alternative setups of the system. Circuit board 16 includes RTL Logic and HW Logic units similar in concept to circuit board 12 while being tailored for the specific hardware it interacts with and/or controls. Thus, the device can simply communicate hardware level control signals to the device for operation without additional intelligence or functionality of a CPU.

Fabric 26 is a switched network fabric, sometimes called switched fabric, network fabric, or fabric. Network nodes, such as circuit boards 12, 14, and 16 connect to fabric 26 through switch 24 according to one embodiment. Switch 24 may be on a circuit board with an RTL logic block as shown in FIG. 1 or may be as a separate block on its own circuit board. Multiple switches can be used in alternative embodiments. Nodes on the fabric arbitrate for transmission rights at high speeds.

One example of a fabric that could be used is RapidIO. RapidIO is an open-standard, switched fabric used in embedded hardware computing. Further, RapidIO is high-performance packet-switched, interconnect technology. RapidIO fabrics can guarantee in-order packet delivery, enabling power and area efficient protocol implementation in hardware. One of the goals of a serial RapidIO (sRIO) network fabric implementation is to replace many discreet signaling lines (driven by hardware logic and/or embedded software code) by multiplexing these control signals as packets on the sRIO network with other network traffic. Thus, in one embodiment, switch 24 is, by way of example without limitation, a switch compliant with the sRIO standard. Other network fabric designs may be used in alternative embodiments.

On fabric 26, a source node is the originator or producer of a network frame. A sink node is the destination or subscriber of a network frame. A source node transforms output from HW Logic or CPU into one or more network frames that are sent out on the network fabric 26. Fabric 26 can route these frames to a single sink node or multi-cast the frames to multiple sink nodes. These frames are received on the sink nodes and replicated for execution on the hardware associated with the sink node. In one embodiment, there is guaranteed in-order delivery of the network frames, with no acknowledgement frame that is required to be returned from a sink node to a source node.

Each node participating in fabric 26 (as virtualized IO) should be synchronized to a common clock. The clocks on each node can be synchronized in a plurality of ways. Global time is the synchronized time value of all participated nodes. Each node may have a global time counter. The clock for these counters can be phase locked or synchronized with a master node so that they do not drift. The synchronization method will dictate the amount of phase delay in the replicated signals. By using time synchronization methods, further discussed in U.S. patent application Ser. No. 14/051,137, incorporated by reference herein, the recovery of the virtualized IO signal on the sink node can be temporally accurate to the source node signal within 10 nanosecond-2 microsecond accuracy, according to some embodiments. The hardware system is best implemented as having a deterministic time. This means that time does not drift or jitter on the various components. Because each node can have its own counter and counters can synchronize, deterministic time predictability is achieved. In addition, the phase delay is deterministic across hardware components.

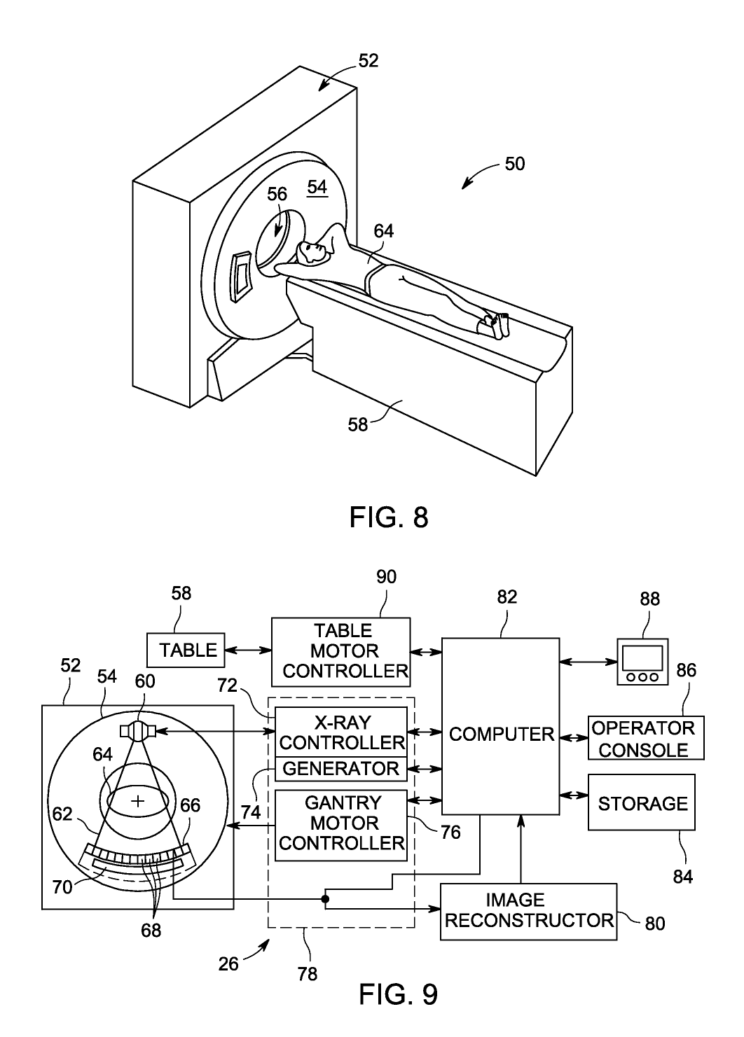

While in one embodiment circuit boards 12, 14, and 16 control hardware components for a Computed Tomography (CT) system as discussed in reference to FIGS. 8 and 9, the circuit boards system of the present invention could be implemented in automotive, marine, rail, airplane, manufacturing, and other hardware systems.

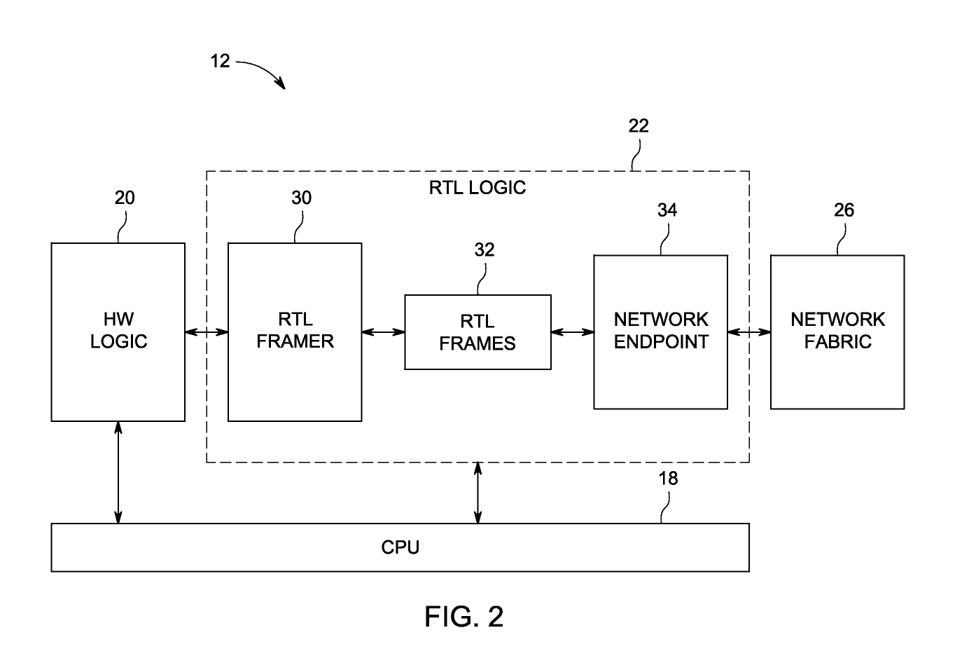

FIG. 2 shows a block diagram detailing RTL logic within a hardware circuit board, according to an embodiment. RTL logic can be implemented in a hardware FPGA or ASIC in alternative embodiments. In FPGA implementations, RTL logic 22 can be updated without physically changing the components of the system, making reconfigurability easier for hardware systems.

HW logic 20 generates a hardware control signal and sends it out as if it was connected to the destination hardware device by a hard wire. In an alternate embodiment, CPU 18 running software may generate a hardware control signal and send it out as if it was connected to the destination hardware device by a wire. RTL Logic 22 receives the hardware control signal and virtualizes it transparently to HW logic 20 and CPU 18, if a CPU is used in the particular system. RTL logic 22 utilizes RTL framer 30, to convert hardware control signals, or hardlines, into frame based equivalents as RTL frames 32. RTL frames 32 are then send to network endpoint 34. Network endpoint 34 adds sufficient frame information to allow the RTL frame to be transmitted over network fabric 26, based on the specific technology implemented for network fabric 26. For example, if network fabric 26 is sRIO-based, then network endpoint 34 would adjust RTL frames 32 to be sRIO compliant. This generates a virtualized IO event, or RTL.

As shown by the bidirectional arrows, RTL logic 22 can also receive and devirtualize an IO event. Network endpoint 34 removes fabric-specific information. RTL frames 32 are then sent to RTL framer 30. RTL framer 30 converts RTL frames into replicated hardware control signals and transmits them to HW logic for control and execution. If network frame is received before an execution time specified in the frame, RTL framer 30 can store the signals in a buffer or FIFO queue for transmission to HW logic 20 at the execution time. Thus, the receiving circuit board may have multiple RTLs received in a time frame and each would be converted into specific hardware control signals to HW logic 20 at the execution times indicated in the RTL frame 32 received by RTL logic 22. If RTL framer 30 is storing a signal for future execution, it can send HW logic 20 a pre_notify signal, as discussed further below. Additional signals may be sent to the CPU based on the specific implementation.

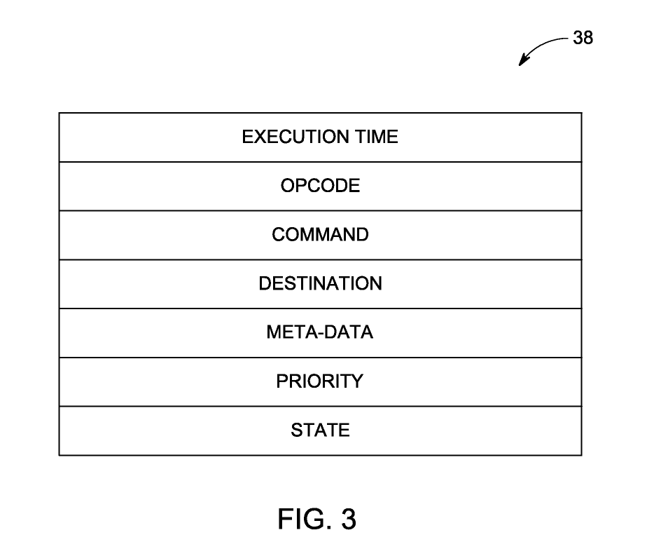

FIG. 3 shows exemplary fields of an RTL frame, according to an embodiment. The term frame is interchangeable with packet. RTL frame 38 includes system, CPU, and/or user selectable fields that allow an RTL IO event to operate. FIG. 3 shows exemplary fields of a frame, but is not indicative of the specific bit lengths of the fields in RTL frame 38. The bit lengths can be different for different fields. For example, priority may be two bits long, while meta-data, or data payload, could be more than 100 words (32 bits per word) long. RTL frame 38 may not include the full network fabric fields that are required to transmit over a network fabric. Those may be added and adjusted by a network endpoint.

Execution time can set the future time, with any added deterministic delay, of a scheduled event, scheduled state, unscheduled state, or other execution event in the hardware system. Execution time can also be set as future time high or future time low, indicating the specific hardware control line type that was received by an RTL framer. Opcode identifies a specific operation that will be performed. There can be both a major and minor opcode to specific aspects of an operation. The operation could be a group event operation or a single hardware execution. Because RTLs are being implemented on a network fabric, the system can add a data or parameter payload, using command or meta-data fields, with the packets to provide more information than would be available with just a wire. Thus, command and meta-data add additional information in some types RTLs. They are not included in all RTL frames. Destination sets the network information on which hardware devices the original hardware control signal was meant to arrive at. This converts hardware-level identification of the destination hardware to virtualized destination information. Priority can set the level of importance the RTL should receive if the network fabric needs to arbitrate access to the fabric. In addition, the receiving hardware may also need priority information regarding the hardware control signal it is receiving. State can be logic “1” or “0” indicating the state of the hardware control signal to be set on the destination hardware.

A hardware device that receives, utilizes, and/or transmits meta-data or data payloads may be one that includes a CPU, as shown in FIG. 1, to assist with more complicated transactions.

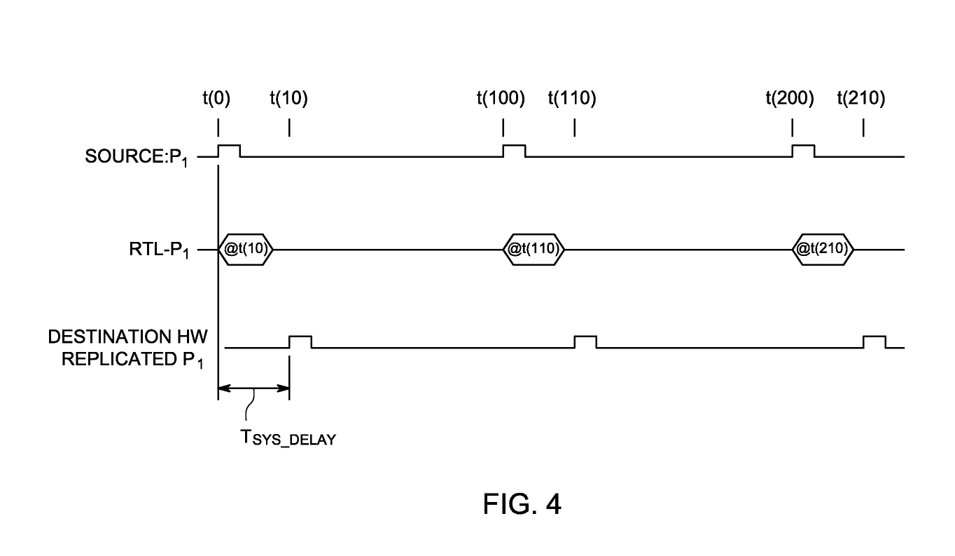

FIG. 4 shows the timing and execution an RTL scheduled event, according to an embodiment. An RTL scheduled event is a time-triggered event that occurs on one or more synchronized destination hardware devices. For example, a gantry control board in a CT system sends a scheduled event to the system hardware components to execute an event. If the event is an imaging scan, the RTL scheduled event goes out from the gantry control board (source node) to many potential hardware components (sink nodes), e.g. the patient table needs to move the patient into the correct position, the x-ray tube needs to pulse x-rays at specific times and voltage levels, the image detector receives images, the collimator may adjust the collimator blade angles based on table position, the gantry motor spins the rotary member to angle the x-rays, as well as other components all coordinating for the full scan operation to occur.

As an RTL scheduled event is a single or periodic event. It is also possible to attach additional meta-data or data payloads (e.g. parametric data from the source, instructions to the source, where is a table, what is the axial angle of a gantry) to the signal which can be used in complex control. The meta-data or data payloads can be loaded and saved in a buffer of RTL logic during the time between when the RTL was sent and when the event should execute (TSYS_DELAY), discussed further below.

FIG. 4 shows that a source node HW logic 20 issues an event hardware control signal P1 with the rising edge of the signal line. RTL logic 22 converts, or transforms, P1 into RTL-P1, the RTL equivalent, which includes frame information of FIG. 3, for example. RTL-P1 includes the execution time. Inside the frame the execution time is listed as @t(10)—for execution of the scheduled event at time=10. This future time is calculated by RTL framer 30 as the original time plus TSYS_DELAY. Thus, even though the frame is on the network fabric from t(0) to t(5), the execution time is delayed until t(10). At t(10), the RTL logic on the receiving circuit board, or sink node, replicates the hardware control signal, Replicated P1, and transmits to HW logic on the sink node for execution. The timing of FIG. 4 is an example, in alternative embodiments, the TSYS_DELAY can be 20, 40, or 100 times longer than the average transmit time across the fabric. For a pulsed signal, scheduled events can occur at regular intervals as shown in FIG. 4.

TSYS_DELAY is a system time delay value that helps determine execution time of the replicated hardware signals at source nodes. As FIG. 4 shows, execution time of the scheduled event (e.g. t(10)) can be the initial signal time (e.g. t(0)) plus TSYS_DELAY (e.g. 10 time units). TSYS_DELAY is a constant that must be large enough to account for: accuracy of the time synchronization across the network fabric, delays in the transport (including accounting for the # of switches between the source and sink nodes), speed of various hardware devices in performing preparatory actions, and bit error rate of the network fabric, depending on specific network fabric implementations. TSYS_DELAY is a constant that the system can dynamically update based on system configurations.

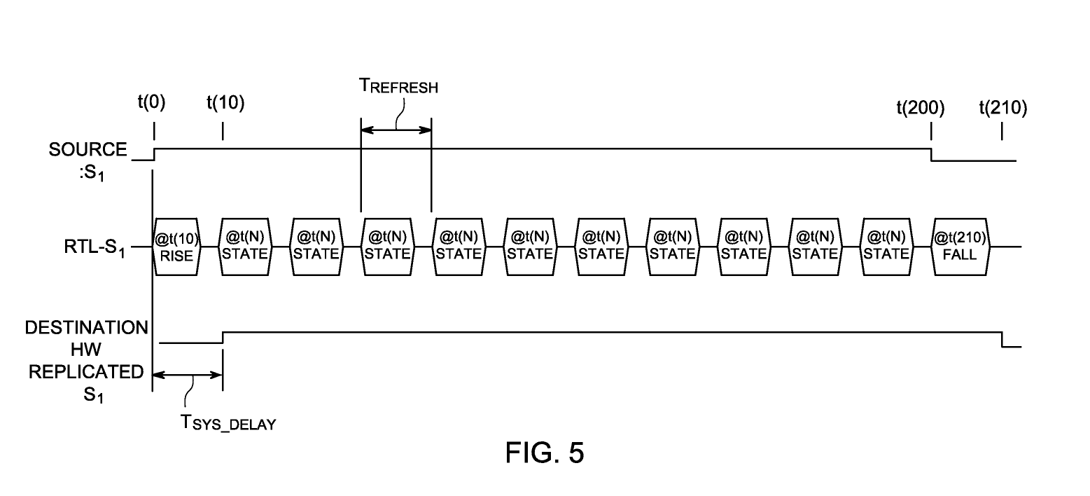

FIG. 5 shows the timing and execution an RTL state event, according to an embodiment. A state event is a logic level signal that needs to be synchronized on one or more sink nodes. An asserted state could be considered a logic “1”, high signal, high state, or logic high. A de-asserted state could be considered a logic “0”, low signal, low state, or logic low. A state event generally does not need the additional opcode, command, or meta-data frame fields of FIG. 3. A state event specific to medical imaging could be an exposure_enable command where the imaging operation must be held active for the duration of the exposure. The source node would want all related sink nodes to be performing their operations consistently during the exposure_enable time period.

FIG. 5 shows the source node HW logic issues a hardware control signal S1, which is initially in a de-assert state. The RTL logic monitors the HW logic. RTL logic is initially not transmitting any RTL frames when HW logic was in the de-asserted state. S1 rises from a de-assert state to an assert state at t(0). At t(0), RTL logic, specifically RTL framer, detects the assert state and generates RTL frames indicating a rising edge with an execution time, RTL-S1—@t(10) rise. The selection of time 10 for future execution is based on the source node understanding of TSYS_DELAY as discussed above. RTL logic, specifically network endpoint, then transmits generated RTL frames to one or more destination sink nodes. At t(10), the RTL logic on the receiving circuit board, or sink node, replicates the hardware control signal, Replicated S1, and transmits an assert state to HW logic on the destination board for execution.

Source node RTL logic monitors S1 and, if still asserted, issues refresh state frames at an interval TREFRESH. This refresh notification adds robustness to the system. TREFRESH is the same across source and sink nodes. TREFRESH is selected based on the criticality of the signal and how quickly the receiving node should respond to a loss of signal. Source node RTL logic will continue sending refresh state frames at pulsed TREFRESH intervals until S1 is de-asserted, returning to a low logic signal. If the source node RTL logic detects a source S1 falling edge it transmits an RTL frame to the one or more sink nodes indicating a falling edge—@t(210) fall. Thus, replicated S1 at the sink node is de-asserted at time 210.

In one embodiment, a loss of RTL frames also indicates a de-asserted state. This could be due to a loss of signal or a cable disconnect, as examples. A timeout time denotes the maximum number of nanoseconds without seeing a refresh packet while the line is high before the sink node RTL logic drops the replicated S1 output line to HW logic.

The state RTL acts a wire replacement technology. Thus, the pulsed nature of the state signal means that the assert state does not have to take up the whole fabric, and other events can happen across the fabric as long as the pulse packets can arrive as scheduled. This is an advantage over a system with pure hardlines and allows the system to communicate many IO events over the shared network fabric.

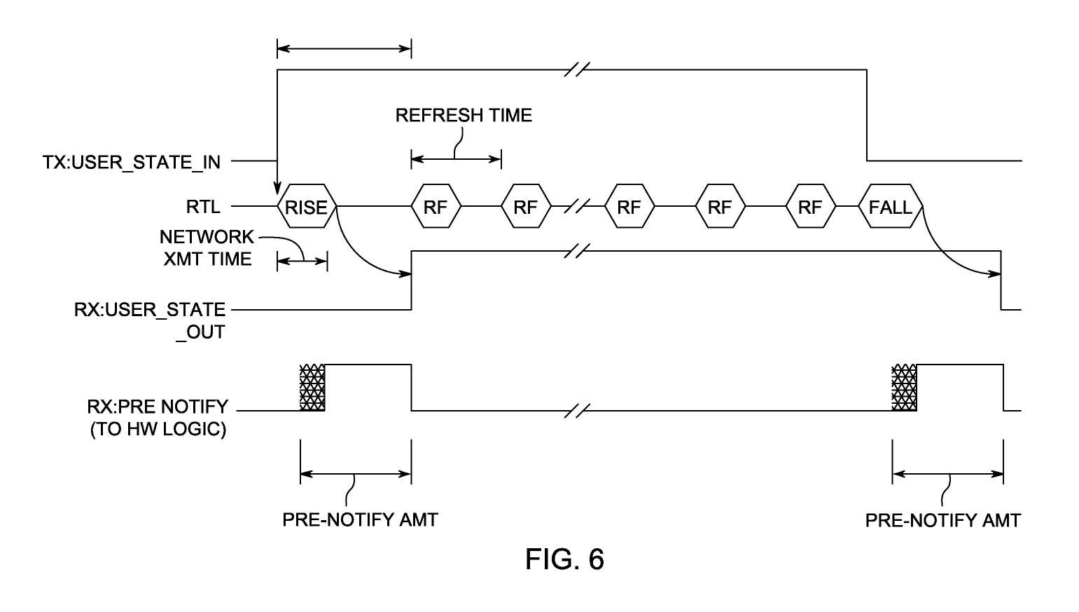

FIG. 6 shows the timing and execution an RTL state event with pre-notify signaling, according to an embodiment. A sink node has the ability to request early notification when state change packets are received using a pre_notify signal. If a sink node has received a RTL frame with state change command for a future time, the sink node HW logic can use the time between the receipt of the RTL frame and the future execution time to prepare the hardware for execution (executing preparatory functions). Examples of actions that may desire or require to start preparing before execution time could be getting data cleared from a detector buffer before the detector will receive additional information at execution time or moving physical components into correct locations for execution of the requested action at execution time. Pre_notify signaling allows for pipelining in the hardware system and allows hardware components to be used most efficiently.

As shown in FIG. 6, source node HW logic (TX) indicates to transmit the user_state_in of logic high. Source node RTL logic transmits a <rise> frame. The <rise> frame is received at sink node (RX) after a network transmit (xmt) time, which is before an execution time. Thus, sink node (RX), specifically communication unit RTL logic, can issue both a pre_notify signal to HW logic immediately as well as the user_state_out logic high signal at execution time. Source node RTL logic continues to send refresh frames (RF) at REFRESH_TIME intervals until the source node HW logic (TX) falls to logic low and a <fall> frame is transmitted. Again, when the change occurs, sink node (RX) can issue a pre-notify signal to HW logic immediately as well as user_state_out logic low signal at execution time. This allows the sink node hardware to execute preparation operations before any change in logic state.

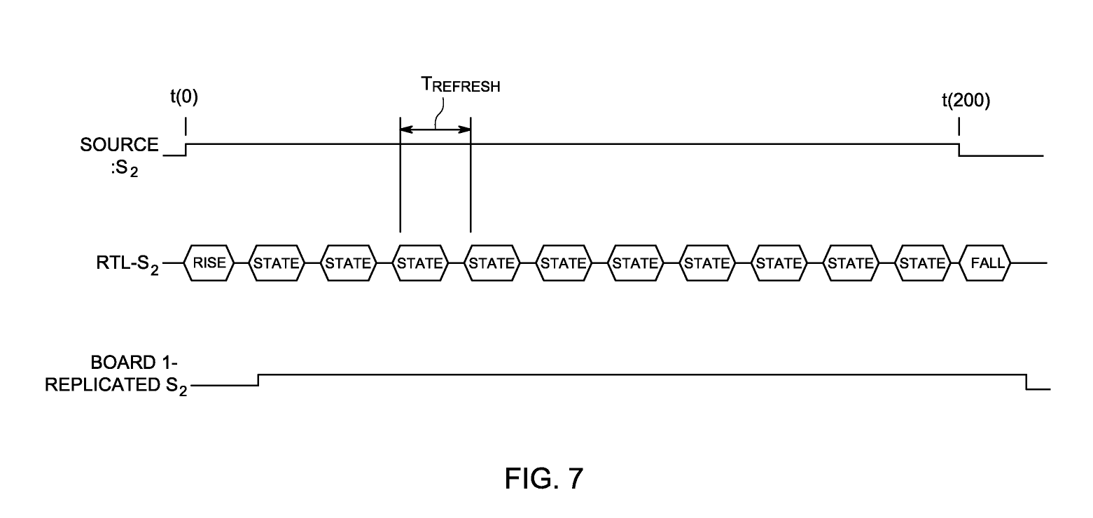

FIG. 7 shows the execution of an RTL unscheduled state, according to an embodiment. In this embodiment, RTL frames do not require an execution time. Sink nodes can replicate the hardware control signals from source nodes immediately upon receipt of the frame.

Source node HW logic issues S2 hardware control signal. Source node RTL logic monitors HW logic and prepares RTL-S2 frames for transmission over the network fabric to one or more sink nodes. RTL-S2 frames do not include a future execution time. Thus, when circuit board 1, a sink node, receives RTL-S2 it can replicate S2 hardware control signal and send it to sink node HW logic for execution on the very next clock signal. Loss of signal can represent de-asserted state.

FIG. 8 shows a perspective view of a CT system, according to an embodiment. FIG. 9 shows a block diagram of a CT system, according to an embodiment. In complex systems like CT systems, multiple processors are networked together for controlling the many hardware components in the system. For example, a CT system may include an X-ray source processor, an X-ray detector processor, a position sensor processor, and a gantry control board processor, all of these being configured for communication with each other via a network fabric. Examples of CT system hardware that could also be connected for communication over the network fabric are the x-ray, collimator, table, gantry tilt motor, alignment lights, gantry control board, and rotary member motor. The CT system could have one master source node, like the gantry control board process, or multiple source nodes.

FIGS. 8 and 9 show a computed tomography (CT) imaging system 50 including a gantry 52. Gantry 52 has a rotary member 54 an x-ray source 60 that projects a beam of x-rays 62 toward a detector assembly 66 on the opposite side of the rotary member 54. X-ray source 60 includes either a stationary target or a rotating target. Detector assembly 66 is formed by a plurality of detectors 68 and data acquisition systems (DAS) 70, and can include a collimator. The plurality of detectors 68 sense the projected x-rays that pass through a subject 64, and DAS 70 converts the data to digital signals for subsequent processing. Each detector 68 produces an analog or digital electrical signal that represents the intensity of an impinging x-ray beam and hence the attenuated beam as it passes through subject 64. During a scan to acquire x-ray projection data, rotary member 54 and the components mounted thereon can rotate about a center of rotation.

Rotation of rotary member 54 and the operation of x-ray source 60 are governed by a control mechanism 78 of CT system 50. Control mechanism 78 (e.g. gantry control board) can include an x-ray controller 72 and generator 74 that provides power and timing signals to x-ray source 60 and a gantry motor controller 76 that controls the rotational speed and position of rotary member 54. Control mechanism 78 can include some or all of the components of circuit board 12. An image reconstructor 80 receives sampled and digitized x-ray data from DAS 70 and performs high speed image reconstruction. The reconstructed image is output to a computer 82 which stores the image in a computer storage device 84.

Computer 82 also receives commands and scanning parameters from an operator via operator console 86 that has some form of operator interface, such as a keyboard, mouse, touch sensitive controller, voice activated controller, or any other suitable input apparatus. Display 88 allows the operator to observe the reconstructed image and other data from computer 82. The operator supplied commands and parameters are used by computer 82 to provide control signals and information to DAS 70, x-ray controller 72, and gantry motor controller 76. In addition, computer 82 operates a table motor controller 90 which controls a motorized table 58 to position subject 64 and gantry 52. Particularly, table 58 moves a subject 64 through a gantry opening 56, or bore, in whole or in part.

Such a hardware input and output system as described herein has many benefits. The system is adaptable to software or firmware updates, such as FPGA updates. This extends the useable life of the system. The system allows for new features without replacing hardware. This is valuable, especially in systems with heavy or expensive hardware. The system allows for communication adjustments without altering physical wires. This benefits the safety and time for field engineers or other people working on such a hardware system. The system has a lighter weight and lower cost by reducing the amount of custom cabling needed in a hardware system. The system is easier to de-bug with only one potential transmission interface to review in case of failures. And combined with the related application, the hardware system can be relied upon to execute with deterministic timing and integrity.

The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a flash memory disk drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A communication system, comprising:
a first communication unit;
a first hardware apparatus connecting to the first communication unit;
a second communication unit;
a network fabric connecting the first communication unit and the second communication unit;
wherein the second communication unit receives a hardware control signal, converts the hardware control signal into network frames including an execution time, and transmits the network frames to the first communication unit via the network fabric;
wherein the first communication unit receives the network frames, converts the network frames into a replicated hardware control signal, and transmits the replicated hardware control signal to the first hardware apparatus; and
wherein the first hardware apparatus performs an action based on the replicated hardware control signal at the execution time.

2. The communication system of claim 1, wherein:
the network fabric is serial RapidIO.

3. The communication system of claim 1, wherein:
the first communication unit, after receiving a related network frame and before the execution time, sends a pre-notify signal to the hardware apparatus; and
the first hardware apparatus, after receiving the pre-notify signal and before the execution time, performs preparatory functions related to the replicated hardware control signal.

4. The communication system of claim 1, wherein:
the first communication unit is implemented on a gantry control board; and
the hardware apparatus is one of a x-ray tube, an image detector, a collimator, or a data acquisition system.

5. The communication system of claim 1, further comprising:
a second hardware apparatus connecting to the second communication unit;
wherein the second communication unit receives second network frames including hardware control information and a second execution time, converts the second network frames into a replicated hardware control signal, and transmits the replicated hardware control signal to the second hardware apparatus at the execution time.

6. The communication system of claim 1, further comprising:
a third communication unit connected to the network fabric;
a third hardware apparatus connected to the third communication unit;
wherein the third communication unit receives the network frames, converts the network frames into a replicated hardware control signal, and transmits the replicated hardware control signal to the third hardware apparatus; and
wherein the third hardware apparatus performs a coordinated action with the first hardware apparatus based on the replicated hardware control signal.

7. The communication system of claim 6, wherein:
the coordinated action is an imaging action.

8. The communication system of claim 1, wherein:
the network frames include meta-data or data payload information in addition to hardware control signal information.

9. The communication system of claim 1, wherein:
the second communication unit transmits periodic refresh frames if the hardware control signal state remains asserted.

10. The communication system of claim 1, wherein:
the second communication unit calculates the execution time using the time of receipt of the hardware control signal and a network delay constant.

11. The communication system of claim 1, wherein:
the first communication unit further comprises a buffer; and
the first communication unit can store multiple hardware control signals for transmission to the first hardware apparatus and their respective execution time in said buffer.

12. A communication method for a communication system with a network fabric connecting multiple communication units, comprising:
receiving a hardware control signal on a source communication unit from a source hardware device;
converting the hardware control signal into one or more RTL frames by the source communication unit, the RTL frames comprising an execution time;
transmitting the RTL frames from the source communication unit to one or more destination communication units over the network fabric;
receiving the RTL frames at the one or more destination communication units;
converting the RTL frames into replicated hardware control signals by the one or more destination communication units;
storing the replicated hardware control signals in the one or more the destination communication units until the execution time;
transmitting, at the execution time, the replicated hardware control signals to one or more destination hardware devices by the respective one or more destination communication units.

13. The communication method of claim 12, wherein:
the network fabric, hardware devices, and communication units are at least partially supported by a medical imaging gantry.

14. The communication method of claim 12, further comprising:
transmitting, by a plurality of destination communication units, the replicated hardware control signal to their respective destination hardware devices at the same execution time; and
performing, by the destination hardware devices, a coordinated action based on the replicated hardware control signal.

15. The communication method of claim 12, further comprising:
transmitting periodic refresh frames from the source communication unit to the one or more destination communication units, if the hardware control signal remains asserted.

16. The communication method of claim 12, further comprising:
transmitting, after receiving a related network frame and before the execution time, a pre-notify signal from at least one destination communication unit to its respective destination hardware device; and
performing, by the respective destination hardware device after receiving the pre-notify signal and before the execution time, preparatory functions related to the replicated hardware control signal.

17. A communication method, comprising:
receiving a network frame from a network fabric, the network frame comprising hardware control signal information and an execution time;
converting the network frame into a replicated hardware control signal; and
outputting the replicated hardware control signal to a hardware apparatus to complete an action at the execution time.

18. The communication method of claim 17, wherein:
each frame further comprises a priority field, an opcode field, and data payload information.

19. The communication method of claim 17, wherein:
the network frames are periodically received; and
the hardware control signal information indicates state assert.

20. The communication method of claim 17, wherein:
the hardware apparatus is one of a x-ray tube, an image detector, a collimator, or a data acquisition system.
